(19) United States
(12) Patent Application Publication
(10) Pub. No.: US 2025/0262885 A1
(43) Pub. Date: Aug. 21, 2025

(54) LIDS AND PAINT TRAY ASSEMBLIES

(71) Applicant: Karen WOLFE, La Crete (CA)

(72) Inventor: Karen WOLFE, La Crete (CA)

(21) Appl. No.: 19/059,753

(22) Filed: Feb. 21, 2025

Related U.S. Application Data
(60) Provisional application No. 63/555,978, filed on Feb. 21, 2024.

(51) Int. Cl. B44D 3/12; B44D 3/14

(52) U.S. Cl. CPC B44D 3/126; B44D 3/14

(57) ABSTRACT

There is provided a lid for covering and sealing a paint roller tray, the lid comprising a cover portion, an exterior side wall, an inner lip, a recess, and a compressible sealing material. There is also provided a tray assembly for sealably holding wet paint and/or a paint roller, the tray assembly comprising a lid and a paint roller tray.

### CROSS-REFERENCE TO RELATED APPLICATION

This application claims prior to and benefit from U.S. Patent Application Ser. No. 63/555,978 filed on Feb. 21, 2024, which is hereby incorporated by reference in its entirety.

### TECHNICAL FIELD

The present disclosure generally relates to lids and tray assemblies, and more particularly to lids and tray assemblies having a compressible sealing material and attachment formations for sealably holding wet paint and/or a paint roller in a paint roller tray.

### BACKGROUND

Painters often use paint roller trays while painting a structure or item. These paint roller trays are typically open-faced to allow for easy access, and have a slanted roll-out portion leading to a planar-floored reservoir which facilitates controlled spreads of paint on a paint roller brush. However, these paint roller trays, being open-faced, expose received paint to air which results in the paint drying out. Lids that engage with these paint roller trays preserve the paint for longer periods of time by slowing down the time it takes to dry out the received paint.

Various drawbacks arise in respect of current lids and there exists a need for improved lids and tray assemblies.

### SUMMARY

The present disclosure provides a lid and a tray assembly for sealably holding wet paint and/or a paint roller. The lids of the present disclosure provide a secure means of releasably engaging with the paint roller tray, and have better sealing capabilities and more functionalities than current lids.

In an embodiment, the present disclosure relates to a lid for covering and sealing a paint roller tray, the lid comprising: a cover portion having a length and a width that are substantially coextensive to a top edge around the perimeter of the paint roller tray; an exterior side wall extending around the cover portion and oriented downwards in relation to a bottom surface of the cover portion, the exterior side wall comprising an attachment formation for releasably engaging the paint roller tray, wherein, when installed on the paint roller tray, the exterior side wall extends around an exterior of the paint roller tray; an inner lip extending downward from the bottom surface and positioned inward from the exterior side wall, wherein the exterior side wall and the inner lip form a channel for receiving the top edge of the paint roller tray; a recess in the exterior side wall for passing a portion of a paint roller handle, the recess being positioned along the exterior side wall at one or both of the longitudinal ends of the lid and extending upwards from a bottom edge of the exterior side wall; and a compressible sealing material provided on the bottom surface within the channel between the inner lip and the exterior side wall, and extending around the perimeter of the cover portion.

In an embodiment, the present disclosure relates to a tray assembly for sealably holding wet paint and/or a paint roller, the tray assembly comprising: any of the exemplary lids of the present disclosure; and a paint roller tray having a cavity defined by a wall, a slanted roll-out portion, and a planar floor of a paint reservoir, the cavity configured to receivably hold the wet paint and/or the paint roller therein, wherein, when in operation, the attachment formation releasably engages the wall to: fully cover the cavity with the cover portion; secure the lid onto the paint roller tray; and contact the compressible sealing material with a top edge of the wall to push out air in the cavity and/or prevent air from entering the cavity.

Other aspects and embodiments of the disclosure are evident in view of the detailed description provided herein.

### BRIEF DESCRIPTION OF THE DRAWINGS

Further advantages, permutations and combinations of the invention will now appear from the above and from the following detailed description of the various particular embodiments of the invention taken together with the accompanying drawings, each of which are intended to be non limiting, in which:

FIG. 1 is a perspective view of an embodiment of a tray assembly according to the present disclosure, showing a first embodiment of a lid releasably engaged with an exemplary paint roller tray.

FIGS. 2A-C show a second embodiment of a lid of the present disclosure, with FIG. 2A showing a top perspective view, FIG. 2B showing a side perspective view from the bottom and FIG. 2C showing a bottom perspective view.

FIGS. 3A-B show a third embodiment of a lid of the present disclosure, with FIG. 3A showing a top perspective view and FIG. 3B showing a bottom perspective view.

FIGS. 4A-B show another embodiment of a tray assembly of the present disclosure having the lid of FIGS. 2A-C releasably engaged on a paint roller tray, wherein FIG. 4A is a top perspective view and FIG. 4B is a side view showing the attachment formation.

FIG. 5 is an extracted view of a side of the tray assembly shown in FIG. 4A bisected along dotted line 5-5 and with a paint roller received therein.

FIG. 6 is a perspective view of stacked exemplary lids according to some embodiments of the present disclosure, wherein the stacked exemplary lids may be configured to fit within a box.

### DETAILED DESCRIPTION

Unless defined otherwise, all technical and scientific terms used herein have the same meaning as commonly understood by one of ordinary skill in the art to which the disclosure belongs. Although any methods and materials similar to or equivalent to those described herein can be used in the practice or testing of the present disclosure, the suitable methods and materials are described below.

Various drawbacks arise in respect of currently existing lids for paint roller trays. For example, existing lids do not provide for a secure and easy means of releasably engaging with the paint roller tray. This may lead to difficulties in removing and/or securing the lid onto the paint roller tray, thereby increasing the probability that some of the received paint is spilled outside of the paint roller tray. As another example, existing lids have inefficient sealing with the top edge of the paint roller tray, particularly around the handle of a paint roller, which leads to the paint drying out quicker than it takes to finish a painting job. Other issues that might arise, in respect of the engagement of the lid with the paint roller tray, are a high profile gap between the lid and a paint roller brush resting on the slanted roll out portion, an inability to position or secure paint cans, confusion with other paint roller trays as to what colour or type of paint is received in each paint roller tray, the paint roller brush slipping on the slanted roll out portion into the reservoir of paint, and so forth.

The present disclosure provides lids and tray assemblies comprising improved designs and features.

The embodiments of the present disclosure pertain to lids and tray assemblies having improved functionality for sealably holding wet paint and/or a paint roller in a paint roller tray. Tray assemblies of the present disclosure have lids for removable engagement with and onto paint roller trays. Lids of the present disclosure have unique features and configurations for improved sealing of paint roller trays holding wet paint and/or a paint roller.

The present disclosure provides a number of advantages over existing technologies. For example, existing lids may prevent paint from drying out for a certain amount of time, but may not provide for adequate sealing to prolong the lifespan of the paint for the time it takes to complete a painting assignment. Moreover, existing lids may be difficult to remove or attach onto paint roller trays, which may lead to paint spilling out. Additionally, paint spilling out or drying out due to these issues can be costly due to having to purchase paint to replace the spilled and/or dried paint.

An advantage of the present disclosure is the provision of tray assemblies having improved characteristics over existing technologies, in particular having lids that are removably engageable with paint roller trays so as to seal said paint roller trays and minimize the drying out of wet paint and/or a wet paint roller.

Another advantage of the present disclosure is the ability to utilize the surface of the lid for additional functionalities. In certain embodiments, the lid comprises configurations for retaining paint cans thereon. In certain embodiments, the lid facilitates labelling or marking to allow users to identify and/or indicate the type of paint contained in the paint roller tray.

In an embodiment, the present disclosure relates to a lid for covering and sealing a paint roller tray, the lid comprising: a cover portion having a length and a width that are substantially coextensive to a top edge around the perimeter of the paint roller tray; an exterior side wall extending around the cover portion and oriented downwards in relation to a bottom surface of the cover portion, the exterior side wall comprising an attachment formation for releasably engaging the paint roller tray, wherein, when installed on the paint roller tray, the exterior side wall extends around an exterior of the paint roller tray; an inner lip extending downward from the bottom surface and positioned inward from the exterior side wall, wherein the exterior side wall and the inner lip form a channel for receiving the top edge of the paint roller tray; a recess in the exterior side wall for passing a portion of a paint roller handle, the recess being positioned along the exterior side wall at one or both of the longitudinal ends of the lid and extending upwards from a bottom edge of the exterior side wall; and a compressible sealing material provided on the bottom surface within the channel between the inner lip and the exterior side wall, and extending around the perimeter of the cover portion.

As used herein, the term “sealing” is intended to have its ordinary meaning. For example and without limitation, sealing in the context of the present disclosure may mean that lids of the present disclose prevent or significantly inhibit the passage of air and/or paint vapors into or out of the interior volume of the paint roller tray when the lid is on the paint roller tray and the attachment formations are engaged. Advantageously, this in turn may prevent the paint vapors from dissipating into the atmosphere. In an embodiment, the lids of the present disclosure maintain a certain air to paint volume ratio within the enclosed paint roller tray to prevent, or at least reduce the extent of, the paint and/or wet paint roller from drying out (e.g. so as to keep the paint wet for later application on surfaces). In some embodiments, paint stored in a tray assembly of the present disclosure may be kept wet for days, weeks, or even months.

As used herein, the term “paint” is intended to have its ordinary meaning. The paint may be of any suitable composition and/or type to be received in a paint roller tray. In an embodiment, the paint is an oil-based paint. In an embodiment, the paint is a water-based paint, such as an acrylic latex water-based paint. While the tray assemblies disclosed herein are discussed as sealably holding paint, a skilled person would appreciate that other viscous materials may be sealably held in the tray assemblies of the present disclosure including, for example and without limitation, stains and outdoor wood treatments.

The “paint roller” disclosed herein may also be of any suitable design and/or configuration. For example, and without limitation, paint rollers may have a handle, a brush cage, and/or a removable brush component. As used herein, the term “paint roller brush” may be used interchangeably with the term “paint roller nap”, in that the removable brush on the paint roller is sometimes also referred to as a nap or cover nap. As the skilled person will appreciate, the “nap” or “cover nap” commonly describes the thickness of the fabric of the brush (i.e. the nap). It may, for example and without limitation, be short (3-5 mm), medium (7-9 mm), long (10-15 mm), or extra long (18-26 mm). Different naps are commonly used for painting different surfaces.

The “paint roller tray” disclosed herein may also be of any suitable design and/or configuration. Many different designs of paint roller trays are known in the art, including paint roller trays having a slanted roll-out portion leading to a planar floor. For example, and without limitation, SIMMS™ and BENNETT™ may offer paint roller trays with these features. It is contemplated that the lids of the present disclosure may be configured to be suitable for use with existing paint roller trays such as those disclosed herein and the like.

The lid as disclosed herein comprises a cover portion and an exterior side wall. When positioned on top of a paint roller tray, the cover portion generally has a length and a width that are substantially coextensive to the top edge around the perimeter of the paint roller tray. By “substantially coextensive”, it is meant that the length and width of the cover portion is substantially the same as the corresponding length and width of the top opening of the paint roller tray, as defined and bounded by the top edge around the perimeter of the paint roller tray. In an embodiment, by substantially coextensive it is meant that the length and width of the cover portion is the same as the corresponding length and width of the top opening of the paint roller tray. In an embodiment, by substantially coextensive it is meant that the length and/or width of the cover portion may be slightly larger than the corresponding length and width of the top opening of the paint roller tray, such as by about 0.1 mm, 0.2 mm, 0.3 mm, 0.4 mm, 0.5 mm, 0.6 mm, 0.7 mm. 0.8 mm, 0.9 mm, 1 mm, 1.5 mm, 2.0 mm, 2.5 mm, 3.0 mm, 3.5 mm, 4.0 mm, 4.5 mm, 5.0 mm, or more. In an embodiment, by substantially coextensive it is meant that the length and/or width of the cover portion may be slightly smaller than the corresponding length and width of the top opening of the paint roller tray, such as by about 0.1 mm, 0.2 mm, 0.3 mm, 0.4 mm, 0.5 mm, 0.6 mm, 0.7 mm. 0.8 mm, 0.9 mm, 1 mm, 1.5 mm, 2.0 mm, 2.5 mm, 3.0 mm, 3.5 mm, 4.0 mm, 4.5 mm, 5.0 mm, or more.

The exterior side wall extends around the cover portion and is oriented downwards in relation to the bottom surface of the cover portion. Thus, when placed over a paint roller tray, the exterior side wall contacts or comes close to contacting the exterior walls of the paint roller tray so as to minimize any air from entering through a gap between the exterior side wall and the wall of the paint roller tray

In an embodiment, the exterior side wall may extend all the way around the cover portion. However, in such an embodiment, there is at least one portion where the height of the exterior side wall is reduced to allow a paint roller brush handle to pass through the region at that portion. For example, in an embodiment the exterior side wall extends all the way around the cover portion at a height of between about 10 mm and about 50 mm downward from the cover portion, but at the portion or portions configured for a paint roller brush to pass through, the height of the exterior side wall extending downwards from the cover portion may only be between about 0.1 mm and 10 mm. In an embodiment, there is one such portion configured for a paint roller brush handle. In an embodiment, there are two such portions configured for a paint roller brush handle, each of the two portions being at the same or opposite ends of the lid.

In an embodiment, the exterior side wall may extend all the way around the cover portion except for in one or more places where there is no exterior side wall. In an embodiment, there is one such place with no exterior side wall configured for a paint roller brush handle to pass through. In an embodiment, there are two such places with no exterior side wall configured for a paint roller brush handle to pass through, each of the two places being at the same or opposite ends of the lid.

In an embodiment, the exterior side wall may be substantially the same height all the way around the lid, with the exception of the portions or places described above configured for a paint roller brush handle to pass through. In an embodiment, the exterior side wall may comprise a plurality of differing heights around the lid.

The lid may be made of any suitable material that substantially prevents the passage of air, for example and without limitation, comprise plastic, metal, wood, composite, glass, polymer, fiber, rubber, or any combination thereof. In a particular embodiment, the lid is made of plastic, for example and without limitation polymethyl methacrylate (PMMA), polycarbonate (PC), polyethylene (PE), polypropylene (PP), polyethylene terephthalate (PETE or PET), polyvinylchloride (PVC), acrylonitrile-butadiene-styrene (ABS), or any combination thereof. In some embodiments, the lid is 3D-printed. In some embodiments, the lid has a thickness between about 0.05 mm to about 4 mm, about 0.075 mm to about 3.5 mm, about 0.1 mm to about 3 mm, about 0.2 mm to about 2.75 mm, about 0.25 mm to about 2.5 mm, or about 0.3 mm to about 2 mm. In an embodiment, the lid comprises a thickness between about 0.25 mm to about 2.5 mm.

In some embodiments, the cover portion comprises a planar surface, absent of any configurations or protrusions thereon. In some embodiments, the cover portion comprises a planar surface having one or more configurations thereon, such as recesses or protrusions.

In some embodiments, the cover portion comprises a multi-level configuration. The multi-level configuration may be an advantageous design such as disclosed herein for maintaining as low a profile as possible to minimize the volume of air inside the paint roller tray when the lid is on, but still allowing a paint roller brush to remain inside. In an embodiment, the multi-level configuration has a lower level at an area around the perimeter of the cover portion that forms the top of the channel in which the compressible sealing material is placed. In an embodiment, the multi-level configuration comprises an elevated region or level positioned inwards from the area above the channel (e.g. positioned inwards from the inner lip).

In some embodiments, the elevated region or level comprises a height relative to a region of the cover portion that forms a top wall of the channel that, when installed on the paint roller tray, maintains the bottom surface the elevated region of the cover portion at a low profile relative to a brush of a paint roller when the brush of the paint roller rests on a slanted roll-out portion of the paint roller tray. In some embodiments, the region of the cover portion that forms a top wall of the channel comprises a planar surface. In some embodiments, the region of the cover portion that forms a top wall of the channel is substantially flat relative to the edge of the cover portion. A skilled person in the art will appreciate that the multi-level configuration may comprise more than one elevated region including, for example and without limitation, two elevated regions or three elevated regions. In some embodiments, further elevated regions may be located within the elevated region.

As used herein, the term “low profile” is intended to refer to a certain amount of clearance or a gap to keep the top of the paint roller brush closer to the bottom surface of the cover portion as compared to the profiles of other tray assemblies. Without being bound by any particular theory, the low profile allows for a smaller air to paint volume ratio in the cavity and paint reservoir as compared to a higher profile. This advantageously allows for clearance of the cover portion above a resting paint roller while simultaneously providing improved preservation of wet paint. In some embodiments, the low profile is a gap of between about 0.1 mm to about 10 mm, about 0.5 mm to about 7.5 mm, or about 1 mm to about 5 mm between the bottom surface of the cover portion and the brush of the paint roller. In some embodiments, the low profile is about 0.1 mm, 0.5 mm, 1.0 mm, 1.5 mm, 2.0 mm, 2.5 mm, 3.0 mm, 3.5 mm, 4.0 mm, 4.5 mm, 5.0 mm, 5.5 mm, 6.0 mm, 6.5 mm, 7.0 mm, 7.5 mm, 8.0 mm, 8.5 mm, 9.0 mm, 9.5 mm, 10.0 mm or more between the bottom surface of the cover portion and the brush of the paint roller. In an embodiment, the advantageous design of the lid as disclosed herein comprises a retention bar to maintain the roller brush in a fixed position, to thereby maintain the low profile gap and to prevent the brush from rolling down into the paint reservoir of the paint roller tray.

As used herein, the term “cavity” is intended to refer to the volume or space enclosed by a tray assembly of the present disclosure. As used herein, the term “paint reservoir” is intended to refer to the portion of the cavity within the paint roller tray above the planar floor. The paint reservoir may be positioned next to the slanted roll-out portion of the paint roller tray. The volume of paint held within the paint reservoir may change and depends on the size and/or configuration of the paint roller tray.

In some embodiments, the height of the elevated region is about 1/32^{nd} of an inch, about 1/16^{th} of an inch, about ⅛^{th} of an inch, about ¼^{th} of an inch, about ½ of an inch, or about 1 inch above the region of the cover portion that forms the top wall of the channel. In some embodiments, the height of the elevated region is about ⅛^{th} of an inch above the region of the cover portion that forms the top wall of the channel. Without being bound by any particular theory, the elevated region provides for clearance of a resting paint roller brush and for room within the paint reservoir for one or more circular depressions (as described herein below).

In some embodiments, the lid comprises a roller retention bar extending downward from the bottom surface of the cover portion, wherein when the lid is installed on the paint roller tray, the roller retention bar prevents the brush of the paint roller from rolling into a paint reservoir of the paint roller tray. In some embodiments, the roller retention bar comprises a formation that is removably attachable to the bottom surface of the cover portion. In some embodiments, the roller retention bar comprises a protrusion that forms a monolithic unit with the remainder of the bottom surface of the cover portion. The roller retention bar may be any suitable size, design, structure, shape, and/or configuration.

In some embodiments, the cover portion comprises one or more circular depressions for resting therein a paint can. In some embodiments, when the lid is installed on the paint roller tray, the one or more circular depressions are positioned above a paint reservoir of the paint roller tray. Without being bound by any particular theory, the one or more circular depressions advantageously reduce the air to paint volume ratio within the tray assembly and are positioned so as not to intrude with a resting paint roller. In some embodiments, the one or more circular depressions are positioned above a slanted roll-out portion of the paint roller tray.

In some embodiments, the one or more circular depressions comprises one depression, two depressions, three depressions, or more than three depressions. In some embodiments, the one or more circular depressions is two depressions, wherein: a first larger circular depression is substantially coextensive in size to the bottom of a larger can of paint (e.g. a gallon can of paint); and a second smaller circular depression is substantially coextensive in size to the bottom of a smaller can of paint (e.g. a litre can of paint), wherein second smaller circular depression is within and further depressed in relation to the first larger circular depression. In some embodiments, the one or more circular depressions comprises one or more further depressions, wherein the one or more depressions is substantially coextensive in size to the bottom of any one or more of a half gallon can of paint, a pint can of paint, a half pint can of paint, or a quarter pint can of paint, wherein the one or more further depressions is within and further depressed in relation to the first larger circular depression and/or the second larger circular depression.

In some embodiments, the lid comprises one or more upwardly oriented protrusions around the circumference of the one or more circular depressions. In an embodiment, the protrusions are around the largest of the circular depressions. The one or more upwardly oriented protrusions may be any suitable design and/or configuration for guiding and securing a received can of paint within the one or more circular depressions. In some embodiments, the one or more upwardly oriented protrusions comprises one protrusion, two protrusions, three protrusions, four protrusions, five protrusions, or more than five protrusions. In some embodiments, the one or more upwardly oriented protrusions comprises at least four protrusions. In some embodiments, when there is more than one protrusion, each protrusion is equidistantly spaced around the circumference of the one or more circular depressions.

In some embodiments, the lid comprises one or more pits around the circumference of the one or more circular depressions. The one or more pits may be any suitable design and/or configuration for allowing a user to pry a received can of paint out from within the one or more circular depressions. In some embodiments, the one or more pits comprises one pit, two pits, three pits, four pits, five pits, or more than five pits. In some embodiments, the one or more pits comprises at least four pits.

In some embodiments, the lid further comprises an indentation for receiving a label and/or a marker for indicating the colour and/or type of paint received in the tray assembly. The indentation may be any suitable design, shape, size, and/or configuration. In some embodiments, the indentation is positioned on the elevated region of the cover portion and further aids in providing the low profile. In some embodiments, the indentation is positioned on the region of the cover portion that forms the top wall of the channel. In some embodiments, the label and/or marker received and/or provided in the indentation comprises an asset tracking means including, but not limited to, barcode, radio-frequency identification (RFID) tag, near-field communication (NFC), Bluetooth™ low energy (BLE), Quick Response (QR) code, or any combination thereof.

In some embodiments, the lid further comprises a feature for fixedly and removably receiving a painting tool, such as a support tool. In an embodiment, the feature is a groove for fixedly and removably receiving the support tool. The groove may comprise any shape, size, or orientation required to fixedly and removably receive the support tool. In some embodiments, the groove is formed by a plurality of protrusions extending upwards from the cover portion, whereby each protrusion has a cutaway. Alignment of the cutaways in each of the protrusion forms a groove capable of receiving the a surface of the support tool. In some embodiments, the groove is formed by the aligned cutaways of between about two protrusions and about six protrusions. In some embodiments, the groove is formed by the aligned cutaways of about four protrusions. In some embodiments, the protrusions are oriented in the direction of the longitudinal length of the lid, such the groove formed by the aligned cutaways is oriented perpendicularly to the protrusions along a width of the lid. In an embodiment, the protrusions are positioned at an end of the lid opposite the one or more recesses that are capable of receiving the handle of the paint brush roller, with the protrusion position atop of the cover portion of the lid. In some embodiments, the support tool is one that is configured to hold a paint roller brush handle and/or an extension thereof. For example, and without limitation, a portion of the support tool releasably engages with the groove to maintain a paint roller brush as it rests atop the lid. In an embodiment, the support tool is a paint tray arm, such as without limitation the Simms™ Paint Tray Arm, which holds extension arms of a paint roller brush upright when the roller brush is resting in the paint tray. The Simms™ Paint Tray Arm has an adjustable clamp for engaging standard plastic and metal paint trays. In an embodiment, the bottom edge of this adjustable clamp is capable of being received by the groove formed, for example, by the described protrusions. As will be appreciated, since the lid would typically be on top of the paint tray and covering the paint tray when the support tool is resting or engaged with the grooves, a contemplated function of the groove for fixedly receiving the support tool is to provide a storage location or position for the support tool when one is not painting. Also, when resting or engaged with the groove, the support tool can advantageously be transported from one location to another as an attached component to the tray assembly described herein, making transport of painting tools an easier procedure.

The lids as described herein comprise an attachment formation. Advantageously, the attachment formation is a component of the exterior side wall and therefore provides a dual purpose in assisting in surrounding a portion of the paint roller tray with the lid and attaching and compressing the lid onto the paint roller tray. In some embodiments, the attachment formation comprises a flexible flap of the exterior side wall. In an embodiment, the flexible flap may be formed by a recess in the exterior side wall on each side of the flexible flap, the recess extending upwards from the bottom edge of the exterior side wall to create a void where the height of the exterior side wall downward from the cover portion is reduced or non-existent. Each recess on either side of the flexible flap may be configured to allow a paint brush handled to pass through the exterior side wall.

In some embodiments, the attachment formation comprises a tooth-like structure on each side of a recess in the exterior side wall. In such embodiment, the recess is again a void in the exterior side wall where the height of the exterior side wall downward from the cover portion is reduced or non-existent. By “tooth-like structure”, it is meant that each portion of the exterior wall on either side of the recess extends downwards from the cover portion further than the adjacent exterior wall on the opposite side. Moreover, in particular embodiments, the is a slit in the exterior side wall on the opposite side of the tooth-like structure from the void to allow each tooth-like structure to serve as a flexible flap. In essence, each of the tooth-like structures is an extension of the exterior side wall at opposing sides of the recess. In some embodiments, the tooth-like structures narrows in width from top to bottom down (i.e., cover portion to bottom edge of exterior side wall) to a point or a rounded point.

A skilled person in the art would understand that, while tooth-like structures are depicted in the embodiments disclosed herein, any other suitable structures and/or configurations of the attachment formation are contemplated. In some embodiments, the attachment formation comprises extensions that are rectangular, oval-like, triangular, flaired and wide-bottomed, or any combination thereof.

In some embodiments, each of the tooth-like structures comprise a hook, clasp, ridge, or other protrusion positioned on an inward facing side at or near a distal end of the tooth-like structure relative to the cover portion, so as to engage with the paint roller tray when the lid is installed on the paint roller tray. In some embodiments, the hook, clasp, ridge, or other protrusion comprises one or more hooks, one or more clasps, one or more ridges, or one or more protrusions (including, but without limitation, a latch, a hook-and-loop connector, a knot, or the like), or any combination thereof. In some embodiments, the hook, clasp, ridge, or other protrusion comprises a hook. In some embodiments, the hook, clasp, ridge, or other protrusion automatically engages with the paint roller tray during installation of the lid onto the paint roller tray. For example, and without limitation, pushing the lid onto the paint roller tray causes the hook, clasp, ridge, or other protrusion to clear and then grip onto a bottom edge of the paint roller tray.

In some embodiments, each of the tooth-like structures is a flexible projection that is capable of being flexed away from the paint roller tray upon application of a force to disengage the hook, clasp, ridge, or other protrusion from the paint roller tray. In some embodiments, the application of the force comprises pulling the tooth-like structures away from the paint roller tray and then lifting the lid off of the paint roller tray.

In some embodiments, the attachment formation comprises two recesses on each side of a single tooth-like structure. In some embodiments, the end of the attachment formation distal to the cover portion is level with the rest of the bottom edge of the exterior side wall. In some embodiments, the tooth-like structure does not comprise a hook, clasp, ridge, or other protrusion.

In some embodiments, the attachment formation releasably engages within a gap in a frame of the paint roller tray. The frame gap may be any suitable size, shape, and/or configuration. In some embodiments, the frame gap comprises a semi-oval in the longitudinal end of the paint roller tray distal to the paint reservoir. In some embodiments, the frame gap comprises a height that is configured to meet the length of the tooth-like structures of the attachment formation such that the hook, clasp, ridge, or other protrusion may engage with the frame gap.

The lids as described herein comprise a compressible sealing material position within a channel between the exterior side wall and an inner lip that extends downward from the bottom surface of the cover portion of the lid. The “compressible sealing material” may be of any suitable design, configuration, and/or material. The compressible sealing material may, for example and without limitation, comprise rubber, plastic, foam, organic fiber, plant material, or any combination thereof. In some embodiments, the compressible sealing material comprises a rubber gasket lining the channel.

In operation, when the lid is placed onto a paint roller tray, the lid is pressed downwards onto the top of the paint roller tray to compress the compressible sealing material and form an airtight or substantially airtight seal. For example, and without limitation, the lid may be pressed downwards by the weight of a paint can resting atop the cover portion and/or the weight of the lid resting on the top edge of the paint roller tray. The attachment formations are then engaged with the paint roller tray to maintain the compressible sealing material in a compressed configuration while the lid is retained onto the paint roller tray. Advantageously, the handle of the paint roller brush, which passes through the exterior side wall at a recess as described herein, is likewise surrounded by the compressible sealing member and pushed sealingly against the top edge of the paint roller tray. Thus, the compressible sealing materials forms a seal around the paint brush handle as well.

In some embodiments, the compressible sealing material is configured to extend a distance from the bottom surface of the cover portion in order to facilitate the low profile gap and/or the application of a pushing force onto the lid. In some embodiments, the compressible sealing material extends about 1.5 inches, about 1 inch, about ½ inch, about ¼ inch, about ⅛ inch, about 1/16 inch, or about 1/32 inch, from the bottom surface of the cover portion. In some embodiments, the compressible sealing material extends about ⅛ inch from the bottom surface of the cover portion. Thus, in an embodiment, the thickness of the compressible sealing materials is between about 1/32 of an inch to about 1.5 inches. In an embodiment, the thickness of the compressible sealing materials is about 1.5 inches, about 1 inch, about ¾ inch, ⅔ inch, about ½ inch, about ⅓ inch, about ¼ inch, about ⅛ inch, about 1/16 inch, or about 1/32 inch.

Without being bound by any particular theory, when the lid is installed onto the paint roller tray, the compressible sealing material may be pushed onto the top edge of the paint roller tray to provide any of the following: push air out of the cavity; prevent external air from entering the cavity; prevent moisture from leaving the cavity; and/or allow the attachment formation to releasably engage the paint roller tray.

In some embodiments, the channel has a width that is substantially coextensive to the compressible sealing material housed therein. In some embodiments, the width of the compressible sealing material is wider than the top edge of the paint roller tray. Without being bound by any particular theory, a thinner top edge of the paint roller tray allows for the compressible sealing material to envelop and wrap around the top edge of the paint roller tray so as to provide improved sealing capabilities and preserve the received wet paint for longer therein. In some embodiments, the width of the compressible sealing material is narrower or substantially coextensive to the top edge of the paint roller tray.

As described herein, one or more recesses in the exterior side wall allow for a passage where a paint brush handle can pass through the exterior wall. In some embodiments, the recess extends upward from the bottom edge of the exterior side wall to a junction point between the exterior side wall and the cover portion, to create a discontinuity in the exterior side wall at the recess. In an embodiment, a recess is positioned at one or both of the longitudinal ends of the paint roller tray, and may be at any suitable location along the exterior side wall. In some embodiments, at least one of the recesses is positioned in the exterior wall so as to be about center of the width of the cover portion. In some embodiments, at least one of the recesses is positioned in the exterior wall so as to be off-center of the width of the cover portion. In some embodiments, there are two recesses in the exterior wall along the width of the cover portion to allow two paint brush handles to pass through the exterior wall.

In some embodiments, the recess extends only partially up the exterior side wall from the bottom edge. In some embodiments, the recess is tapered towards the cover portion. In some embodiments, the recess comprises at least a width that is substantially coextensive to the width of a portion of the paint roller handle.

In some embodiments, the inner lip comprises an inner lip recess that is aligned with the recess so as to allow the paint roller handle to pass through both the recess and the inner lip recess. In some embodiments, when installed on the paint roller tray, the compressible sealing material forms a seal around the portion of the paint roller handle that is passed through the recess. Without being bound by any particular theory, providing the compressible sealing material along the inner lip recess allows for an improved seal around the paint roller tray as compared to other paint roller trays that do not seal around the paint roller handle.

In some embodiments, the lid is configured to be stackable on top of each other. In some embodiments, the stackable lids may be placed and transported in a box, a container, a bag, or the like. In some embodiments, the exterior side wall comprises stability support pillars. Without being bound by any particular theory, the stability support pillars may assist with stacking lids of the present disclosure atop of one another by preventing the lids from compressing too much so as to release from stacking.

In an embodiment, the present disclosure relates to a tray assembly for sealably holding wet paint and/or a paint roller, the tray assembly comprising: any of the exemplary lids of the present disclosure; and a paint roller tray having a cavity defined by a wall, a slanted roll-out portion, and a planar floor of a paint reservoir, the cavity configured to receivably hold the wet paint and/or the paint roller therein, wherein, when in operation, the attachment formation releasably engages the wall to: fully cover the cavity with the cover portion; secure the lid onto the paint roller tray; and contact the compressible sealing material with a top edge of the wall to push out air in the cavity and/or prevent air from entering the cavity.

Reference will now be made in detail to exemplary embodiments of the disclosure, wherein numerals refer to like components, examples of which are illustrated in the accompanying drawings that further show exemplary embodiments, without limitation.

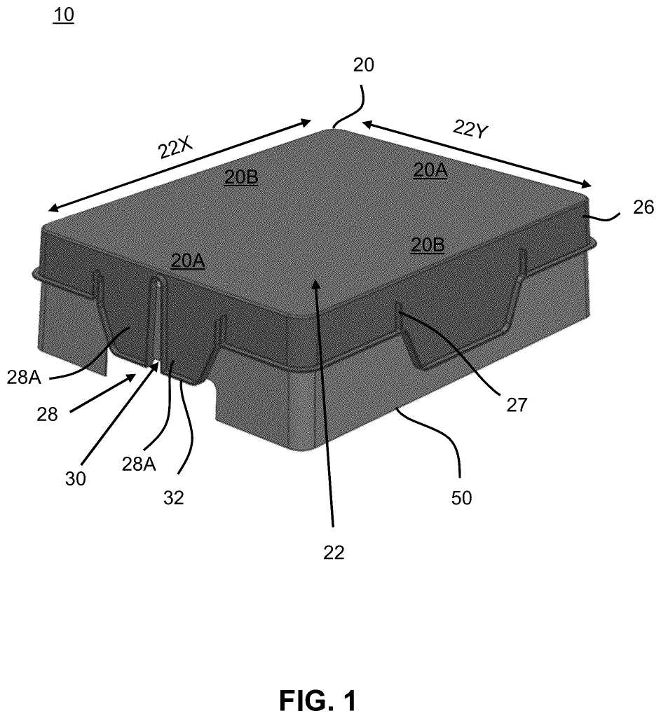

FIG. 1 illustrates an exemplary embodiment of a tray assembly 10 according to the present disclosure, wherein the tray assembly 10 comprises a lid 20 and a paint roller tray 50.

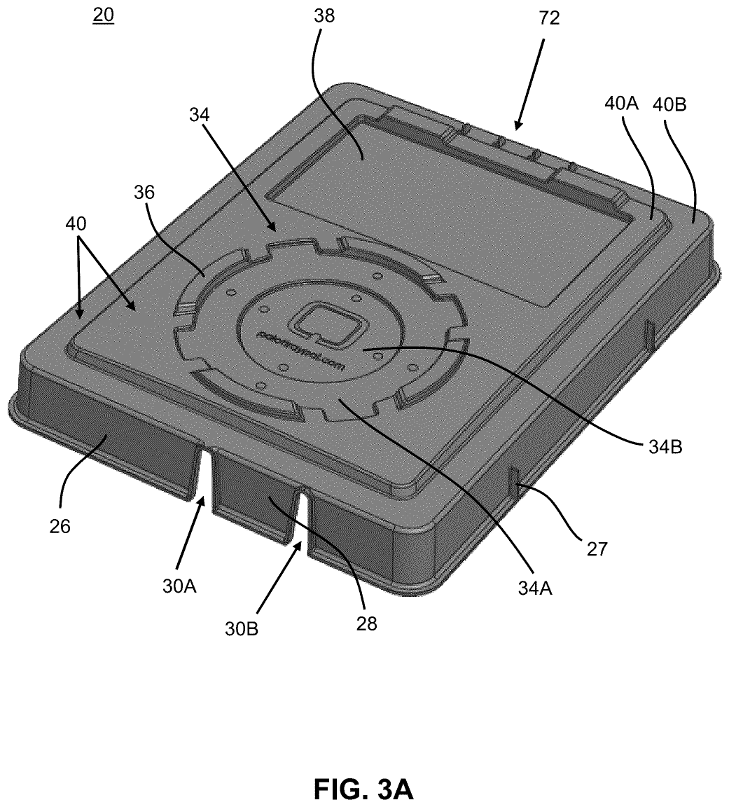

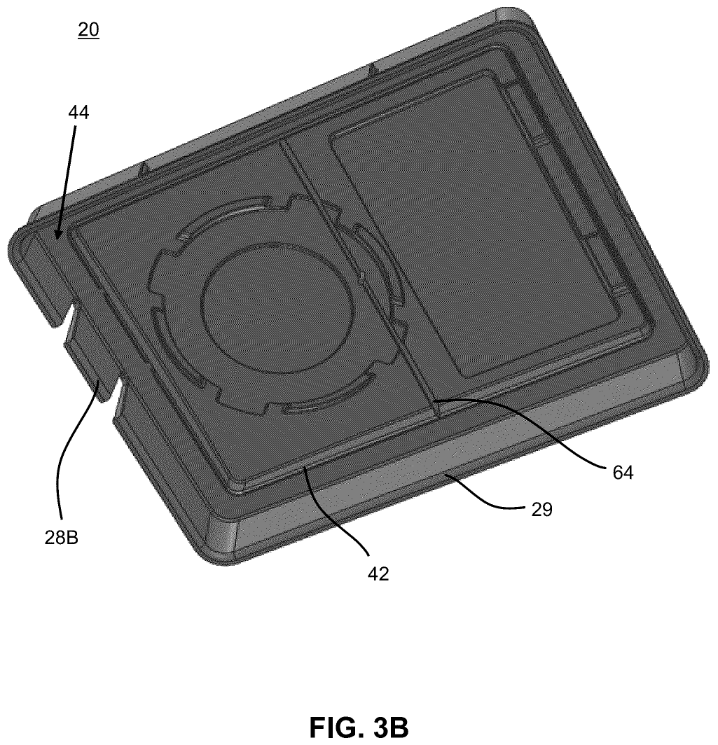

The lid 20 comprises a cover portion 22 and an exterior side wall 26. The cover portion 22 has a length 22X and a width 22Y that are substantially coextensive to the lengths and widths of the paint roller tray 50. In some embodiments, as shown in FIGS. 1 and 3A, the exterior side wall 26 may have stability support pillars 27 oriented in an up-down orientation (in reference to the cover portion being at the top and the bottom edge of the exterior side wall being at the bottom). The exterior side wall 26 comprises an attachment formation 28 located at a longitudinal end 20A of the lid 20. The exterior side wall 26 encompasses the perimeter of the paint roller tray 50 and stretch around the longitudinal ends 20A and the latitudinal ends 20B of the lid 20. The attachment formation 28 comprises tooth-like structures 28A located on either side of a recess 30 that starts from a bottom edge 32 of the exterior side wall 26 and tapers towards the cover portion 22. The tooth-like structures 28A engage with a frame gap 52 of the paint roller tray 50 via a hook, clasp, ridge, or other protrusion 28B (shown in FIG. 3). The cover portion 22 comprises a planar surface, absent of any configurations or formations.

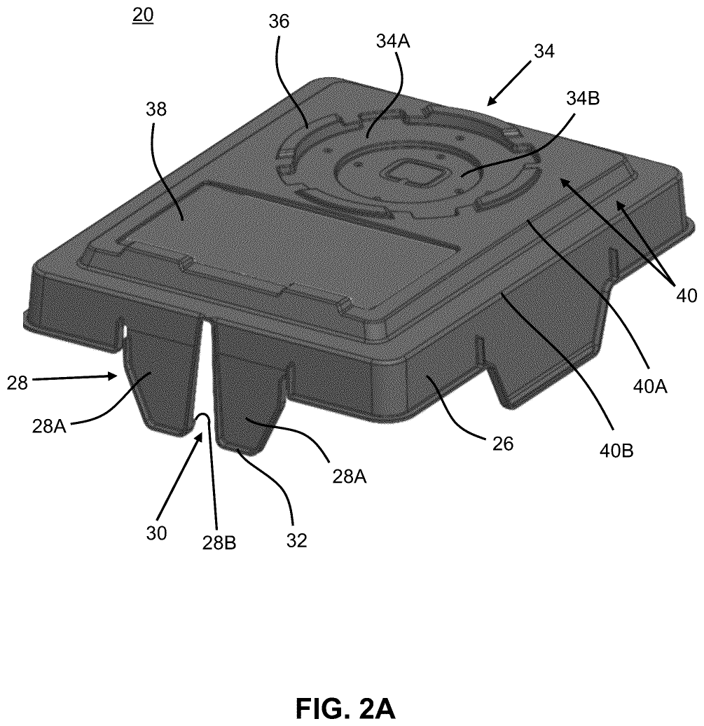

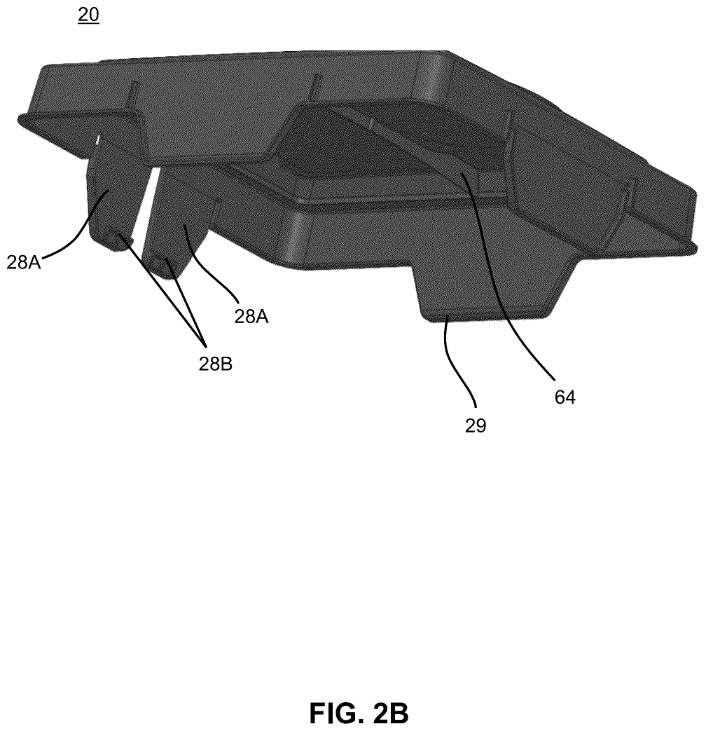

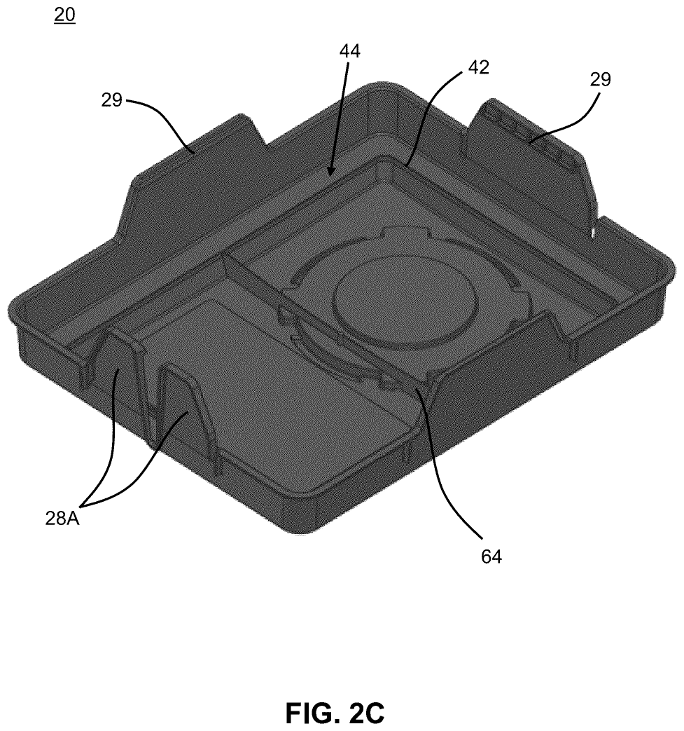

FIGS. 2A-C illustrates another exemplary embodiment of the lid 20 according to the present disclosure. FIG. 2A shows a perspective front view of the top side of the lid 20, FIG. 2B shows a perspective view from the bottom of the side of the lid 20, and FIG. 2C shows a perspective view of the bottom side of the lid 20. In contrast to the lid 20 of FIG. 1, the lid of FIG. 2A-C features a multi-level configuration (40A/40B) and comprises recesses 34 and protrusions 36 in the cover portion 22.

FIGS. 3A-B illustrates another exemplary embodiment of the lid 20 according to the present disclosure. FIG. 3A shows a perspective front view of the top side of the lid 20 and FIG. 3B shows a perspective view of the bottom side of the lid 20. In contrast to the lid 20 of FIG. 2A-C, the lid 20 of FIG. 3A-B comprise two separate recesses 30 for passage therethrough of the handle of a paint roller brush. Also, the attachment formation 28 is of a different configuration whereby the flexible flap that forms the attachment formation 28 is of the same height as the remainder of the exterior side wall 26. The lid may further comprise a groove 72 for fixedly and movably receiving a support tool (not shown).

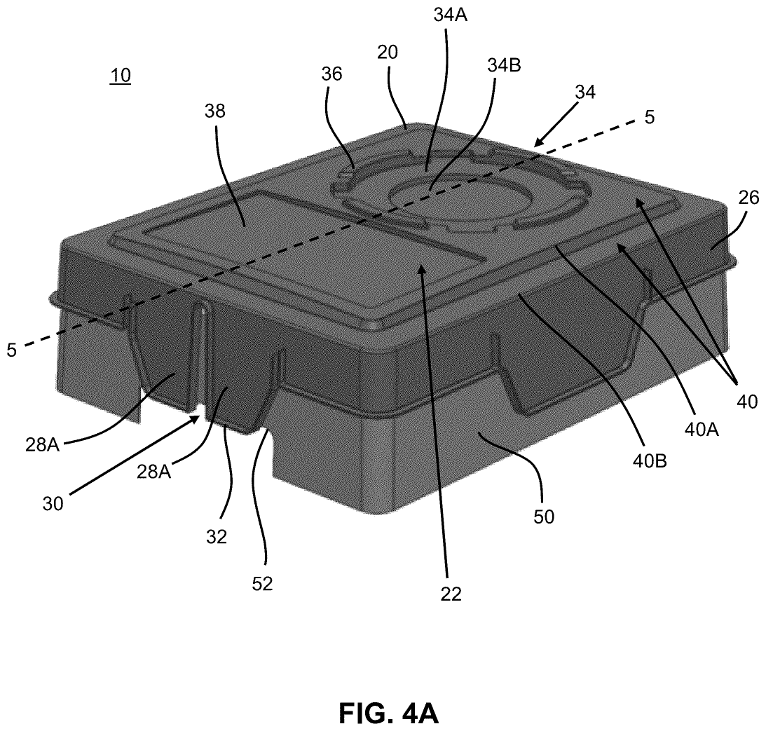

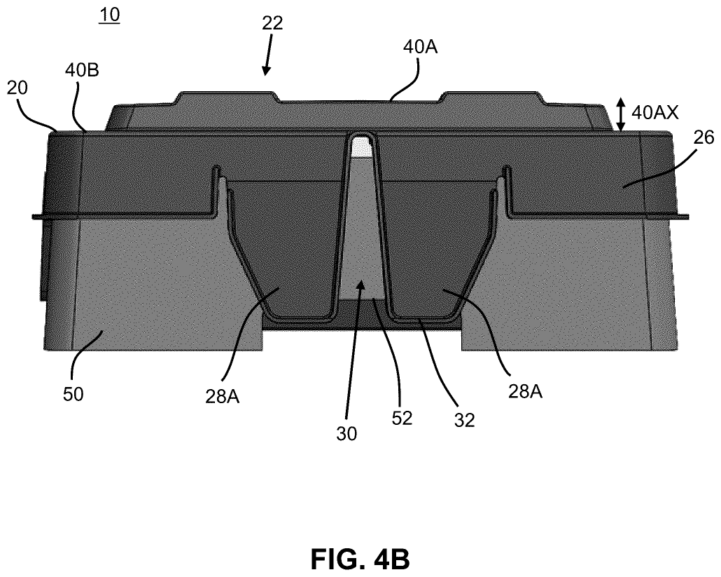

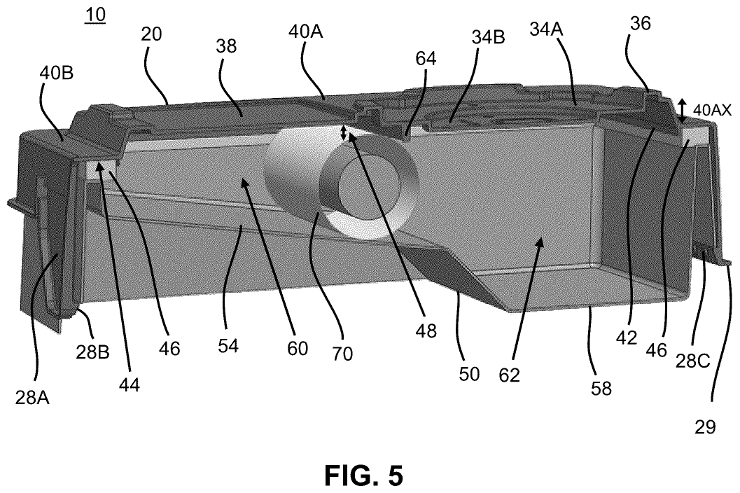

FIG. 4A-B illustrates another exemplary embodiment of the tray assembly 10 according to the present disclosure, wherein the tray assembly 10 comprises the lid 20 of FIGS. 2A-C releasably engaged on a paint roller tray 50. FIG. 4A shows a perspective view of the front side of the tray assembly 10 while FIG. 4B shows a front view of the tray assembly 10. FIG. 5 shows an extracted view of the tray assembly of FIG. 4A along dotted line 5-5 with a paint roller brush contained therein.

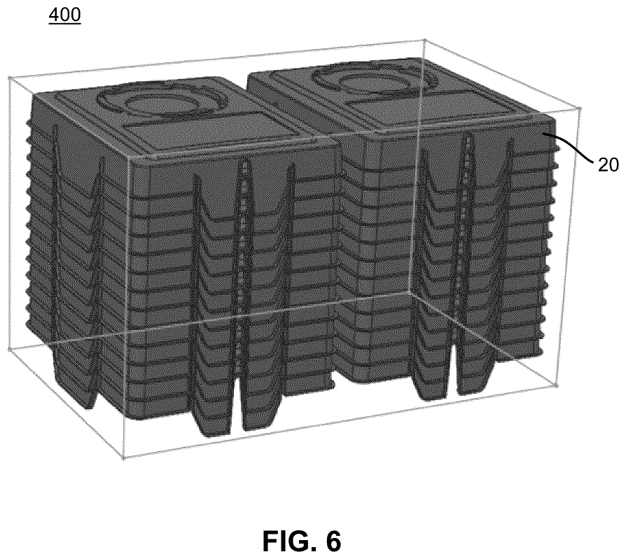

FIG. 6 shows an embodiment of lids 20 of the present disclosure stacked and configured to fit within a box.

Referring to both FIGS. 2A-C, 3A-B and 4A-B, in some embodiments the lid 20 comprises one or more circular depressions 34, one or more upwardly oriented protrusions 36, an indentation 38, and a multi-level configuration 40. The one or more circular depressions 34 comprise a first circular depression 34A that is substantially coextensive in size to the bottom of a gallon can of paint and a second circular depression 34B that is substantially coextensive in size to the bottom of a litre can of paint. The second circular depression 34B is within and further depressed in relation to the first larger circular depression 34A. The one or more upwardly oriented protrusions 36 are positioned around the circumference of the one or more circular depressions 34. The multi-level configuration 40 comprises an elevated region 40A and a channel region 40B. The elevated region 40A has a height 40AX above the channel region 40B. The indentation 38 may receive a label or any other suitable marking to indicate what type and colour of paint is received within the paint roller tray 50.

FIG. 5 illustrates an exploded view of the tray assembly 10 shown in FIG. 2A with a paint roller 70 resting in the paint roller tray 50.

The lid 20 is secured onto the paint roller tray 50 by engagement of the attachment formation 28, specifically comprising an engagement formation 28B (e.g. a hook, clasp, ridge, or other protrusion), with the frame gap 52. In some embodiments, the exterior side wall 26 may include, at positions other than on the attachment formation 28, additional engagement formations 29 on an inside surface of the exterior side wall 26 for maintaining the lid 20 on the paint roller tray 50. In an embodiment, there is at least one engagement formation (28B/29) on each side of the lid 20. The lid 20 comprises a compressible sealing material 46 contained within a channel 44 defined between the exterior side wall 26 and an inner lip 42. When releasably engaged, the compressible sealing material 46 contacts and seals around a top edge 56 of the paint roller tray 50.

The lid 20 is configured to maintain a low profile such that there is a desired gap 48 between the bottom surface 24 of the cover portion 22 and a top of the paint roller 70, when the paint roller 70 is resting within the cavity 60 on the slanted roll-out tray portion 54 of the paint roller tray 50. The paint roller 70 is stopped from entering into a paint reservoir 62 above the tray planar floor 58 (which may be holding a volume of paint) through a retention bar 64 positioned on the bottom surface 24. A handle (not shown) of the paint roller 70 is passed through the recess 30 in the exterior side wall 26 and an inner recess (not shown) in the inner lip 42. The compressible sealing material 46 is provided throughout the entirety of the channel 44 such that the compressible sealing material 46 also contacts and seals the portion of the paint roller 70 passed through the inner recess.

FIG. 6 illustrates an exemplary embodiment of a plurality of lids stacked on top of one another 400.

It has been found through experimentation that the lid described herein, in association with a paint tray to form a paint tray assembly as described herein, is capable of maintaining paint in a satisfactory and usable condition for at least one month or more, whereby the sealing is so effective so as to substantially prevent the paint from drying for these extended periods of time of at least one month. In such experiments, paint tray assemblies as described herein, employing the lid as described herein, were left in a sealed configuration for more than one month and then the lid was removed and the paint tested for satisfactory usability, with such being found and observed.

In the present disclosure, all terms referred to in singular form are meant to encompass plural forms of the same. Likewise, all terms referred to in plural form are meant to encompass singular forms of the same. Unless defined otherwise, all technical and scientific terms used herein have the same meaning as commonly understood by one of ordinary skill in the art to which this disclosure pertains.

As used herein, the term “about” refers to an approximately +/−10% variation from a given value. It is to be understood that such a variation is always included in any given value provided herein, whether or not it is specifically referred to.

It should be understood that the compositions and methods are described in terms of “comprising,” “containing,” or “including” various components or steps, the compositions and methods can also “consist essentially of or “consist of the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Although individual embodiments are dis-cussed, the disclosure covers all combinations of all those embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure. If there is any conflict in the usages of a word or term in this specification and one or more patent(s) or other documents that may be referenced herein, the definitions that are consistent with this specification should be adopted.

Many obvious variations of the embodiments set out herein will suggest themselves to those skilled in the art in light of the present disclosure. Such obvious variations are within the full intended scope of the appended claims.

1. A lid for covering and sealing a paint roller tray, the lid comprising:
a cover portion having a length and a width that are substantially coextensive to a top edge around the perimeter of the paint roller tray;
an exterior side wall extending around the cover portion and oriented downwards in relation to a bottom surface of the cover portion, the exterior side wall comprising an attachment formation for releasably engaging the paint roller tray, wherein, when installed on the paint roller tray, the exterior side wall extends around an exterior of the paint roller tray;
an inner lip extending downward from the bottom surface and positioned inward from the exterior side wall, wherein the exterior side wall and the inner lip form a channel for receiving the top edge of the paint roller tray;
a recess in the exterior side wall for passing a portion of a paint roller handle, the recess being positioned along the exterior side wall at one or both of the longitudinal ends of the lid and extending upwards from a bottom edge of the exterior side wall; and
a compressible sealing material provided on the bottom surface within the channel between the inner lip and the exterior side wall, and extending around the perimeter of the cover portion.

2. The lid of claim 1, wherein the cover portion comprises a multi-level configuration with an elevated region positioned inwards from the inner lip.

3. The lid of claim 2, wherein the elevated region comprises a height relative to a region of the cover portion that forms a wall of the channel that, when installed on the paint roller tray, maintains the bottom surface of the cover portion at a low profile relative to a brush of a paint roller when the brush of the paint roller rests on a slanted roll-out portion of the paint roller tray.

4. The lid of claim 3, wherein the low profile is a gap of between about 0.1 mm to about 10 mm between the bottom surface of the cover portion and the brush of the paint roller.

5. The lid of claim 3 or 4, wherein the height of the elevated region is about ⅛^{th} of an inch above the region of the cover portion that forms the wall of the channel.

6. The lid of any one of claims 3 to 5, which comprises a roller retention bar extending downward from the bottom surface of the cover portion, wherein when the lid is installed on the paint roller tray, the roller retention bar prevents the brush of the paint roller from rolling into a paint reservoir of the paint roller tray.

7. The lid of any one of claims 1 to 6, wherein the cover portion comprises one or more circular depressions for resting therein a paint can.

8. The lid of claim 7, wherein, when the lid is installed on the paint roller tray, the one or more circular depressions are positioned above a paint reservoir of the paint roller tray.

9. The lid of claim 8, wherein the one or more circular depressions is two depressions, wherein:
a first larger circular depression is substantially coextensive in size to the bottom of a gallon can of paint; and
a second smaller circular depression is substantially coextensive in size to the bottom of a litre can of paint,
wherein second smaller circular depression is within and further depressed in relation to the first larger circular depression.

10. The lid of any one of claims 7 to 9, wherein there are one or more upwardly oriented protrusions around the circumference of the one or more circular depressions.

11. The lid of any one of claims 1 to 10, wherein the attachment formation comprises a tooth-like structure on each side of the recess, each of the tooth-like structures being an extension of the exterior side wall at opposing sides of the recess.

12. The lid of claim 11, wherein each of the tooth-like structures comprise a hook, clasp, ridge, or other protrusion positioned on an inward facing side at or near a distal end of the tooth-like structure relative to the cover portion, so as to engage with the paint roller tray when the lid is installed on the paint roller tray.

13. The lid of claim 12, wherein the hook, clasp, ridge, or other protrusion automatically engages with the paint roller tray during installation of the lid onto the paint roller tray.

14. The lid of any one of claims 11 to 13, wherein each of the tooth-like structures is a flexible projection that is capable of being flexed away from the paint roller tray upon application of a force to disengage the hook, clasp, ridge, or other protrusion from the paint roller tray.

15. The lid of any one of claims 1 to 14, wherein the attachment formation releasably engages within a gap in a frame of the paint roller tray.

16. The lid of any one of claims 1 to 15, wherein the channel has a width that is substantially coextensive to the compressible sealing material housed therein.

17. The lid of claim 16, wherein the width of the compressible sealing material is wider than the top edge of the paint roller tray.

18. The lid of any one of claims 1 to 17, wherein the recess extends upward from the bottom edge of the exterior side wall to a junction point between the exterior side wall and the cover portion, to create a discontinuity in the exterior side wall at the recess.

19. The lid of any one of claims 1 to 17, wherein the recess extends only partially up the exterior side wall from the bottom edge.

20. The lid of any one of claims 1 to 19, wherein the recess is tapered towards the cover portion.

21. The lid of any one of claims 1 to 20, wherein the inner lip comprises an inner lip recess that is aligned with the recess so as to allow the paint roller handle to pass through both the recess and the inner lip recess.

22. The lid of any one of claims 1 to 21, wherein, when installed on the paint roller tray, the compressible sealing material forms a seal around the portion of the paint roller handle that is passed through the recess.

23. The lid of any one of claims 1 to 22, configured to be stackable on top of each other.

24. The lid of any one of claims 1 to 23, wherein the cover portion comprises one or more support tool protrusions having aligned cutaways that form a groove for fixedly receiving a support tool.

25. A tray assembly for sealably holding wet paint and/or a paint roller, the tray assembly comprising:
the lid of any one of claims 1 to 24; and
a paint roller tray having a cavity defined by a wall, a slanted roll-out portion, and a planar floor of a paint reservoir, the cavity configured to receivably hold the wet paint and/or the paint roller therein,
wherein, when in operation, the attachment formation releasably engages the wall to:
fully cover the cavity with the cover portion;
secure the lid onto the paint roller tray; and
contact the compressible sealing material with a top edge of the wall to push out air in the cavity and/or prevent air from entering the cavity.
